(19) United States
(12) Patent Application Publication
(10) Pub. No.: US 2020/0284079 A1
(43) Pub. Date: Sep. 10, 2020

(54) PROTECTIVE COVER DEVICE AND METHOD TO MANUFACTURE SAID COVER DEVICE

(71) Applicant: Phrixos PRODROMOU, Ruislip Middlesex (GB)

(72) Inventor: Phrixos PRODROMOU, Ruislip Middlesex (GB)

(21) Appl. No.: 16/644,479

(22) PCT Filed: Sep. 6, 2018
(86) PCT No.: PCT/GB18/52523

§ 371 Date: Mar. 4, 2020

(30) Foreign Application Priority Data
Sep. 11, 2017 (GB) 1714561.6

(51) Int. Cl. E05D 11/00; E05D 9/00; E06B 7/36

(52) U.S. Cl. CPC E05D 11/0054; E05D 2011/0072; E06B 7/367; E05D 9/005

(57) ABSTRACT

A cover device for covering the angle formed between the edge of a hinged door and a door frame includes first and second elongate bodies, each body having substantially parallel sides and divided by hinge lines parallel to the sides into a plurality of elongate panels. The first body is mountable at one end to the door, and the second body is mountable at one end to a frame relative to which the door hinges. The hingeable connection between the bodies is by at least one longitudinal channel and at least one longitudinal protrusion which locates within the channel to be removeably held within it but able to move longitudinally with respect to it, and thereby to act as a hinge whilst enabling the relative longitudinal movement between the elongate bodies.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

This invention relates to a protective cover device. In particular it relates to a protective device of the type known as a hinge guard for covering the angle formed between the edge of a hinged door and a doorframe to form a barrier preventing access to the angle by fingers so as to avoid pinching or similar injuries.

### 2. Description of Related Art Including Information Disclosed Under 37 CFR 1.97 and 37 CFR 1.98

Covers of this type are known from, for example, GB-A-231078 and GB-A-2505720.

Each of these provide a hinge cover device formed by an elongate strip 1, preferably of length corresponding to the height of door and which is suitably formed as a substantially flat extrusion of polypropylene, PVC or other plastic material. This strip has parallel sides and is divided by parallel hinge lines 2 into a plurality of elongate panels. A first outer one of these is adapted to be fixed to the face of a door adjacent to the door edge and the second remote of these is adapted to be fixed to the doorframe, adjacent to that part of the doorframe which faces the door when the door is fully closed. The panels are separated hinge lines, which may be of reduced thickness compared to the panel and which enables the panels to hinge relative to each other, by acting as a living hinge.

The arrangement is generally that when a door is fully open the cover device forms a generally convex cover over the angle between the door and the frame but as the door closes onto the hinge the panels begin to hinge against each other to form a general polygonal hollow shape with bends in and thereby provides a relatively stiff barrier preventing access to the angle between a door and frame. In the fully closed position of the door of these prior art arrangements, the cover device folds to form a hollow polygonal structure which is substantially rectangular, blends in well with the door and doorframe if it is the same colour, and which prevents fingers being inserted into the frame and therefore possibly damaged as the door opens or closes. At all times the current device forms a barrier to the angle between the door and the frame and this barrier can form various polygonal shapes according to the opening state of the door.

GB-A-2505720 introduces further panels which can concertina to abut against each other and which enables such a device to be used on a larger door and door opening angle than that of GB-A-2321078.

However, there are still some doors which cannot be protected, in particular thick doors or very wide opening doors as might be used in public buildings such as hospitals and so on. In addition, the previously proposed devices are problematic when used with doors with rising butt hinges, in which the door rises as it is opened in order to provide clearance over a carpet, for example. As the device is fixed both to a door and doorframe, the device is unable to cope with the door rising relative to the frame as it is opened without tending to pull the cover device off the surface of the door or frame to which it is attached.

### BRIEF SUMMARY OF THE INVENTION

The present invention arose in attempt to provide an improved protective cover device.

In a first aspect the invention provides a cover device for covering the angle formed between the edge of a hinged door and a doorframe, comprising first and second elongate bodies, each body having substantially parallel sides and divided by hinge lines parallel to the sides into a plurality of elongate panels, wherein at least some of the panels are hingable relative to an adjacent panel in order to enable at least some of the panels to concertina relative to each other, the first body being mountable at one end to the door and the second body being mountable at one end to a frame relative to which the door hinges, and the respective free ends of the first and second bodies being removeably hingably connected together and which enables a degree of relative movement of one body, in a direction parallel to the hinge lines, relative to the other body.

Preferably, the first body includes a channel and the second body includes a protrusion which fits into the channel (typically from the top or bottom and which slide into position with respect to the first body) such that the protrusion enables a relative angular motion whilst enabling the second body to have a degree of free (ie generally vertically) movement in a direction parallel to the hinge lines relative to the first body. Thus, if the door has rising butt hinges, as the door is closed, the body attached to that door can rise slightly relative to the body attached to the frame to thereby accommodate the rising of the door without stressing the connection.

In a further embodiment, each of the bodies includes a channel and a third member having two protrusions is provided, one of which fits in the first body's channel and the other which fits within the second body's channel, the third body connecting and enabling relative hinging and longitudinal movement between the first and second body.

Alternatively the third (connection member) may have the channels and the bodies and the protrusions, or the connection member may have one channel and one protrusion, one body having a channel and the other having a protrusion.

The first and/or second body may be formed of two different plastics, one having more rigidity than the other. They may be formed by a co-extrusion process.

The invention further provides a door and frame protected by a cover device as above.

### BRIEF DESCRIPTION OF THE SEVERAL VIEWS OF THE DRAWINGS

Embodiments of the invention will now be described, by way of example only, with reference to the accompanying drawings.

FIG. 1 shows the cover device formed of two bodies;

FIG. 2 shows the cover device in position between a door and frame with the door partially opened;

FIG. 3 shows the device with the door open further;

FIG. 4 shows the device with the door substantially closed;

FIG. 5 shows a top view of the device with the door closed;

FIG. 6 shows an alternative door cover;

FIG. 7 shows one of the bodies in a folded position;

FIG. 8 shows the cover of FIG. 7 with the door partly open;

FIG. 9 shows the cover of FIG. 6 with the door further open;

FIG. 10 shows the cover of FIG. 6 with the door substantially closed;

FIG. 11 shows the door of FIG. 6 from a top view with a cover attached;

FIGS. 12 and 13 show alternative embodiments; and

FIGS. 14 and 15 show a co-extrusion technology.

### DETAILED DESCRIPTION OF THE INVENTION

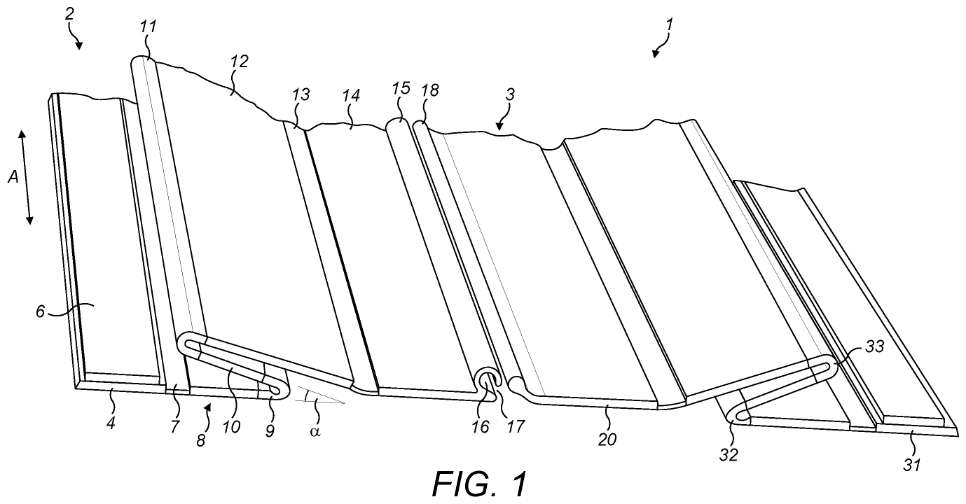

Referring to the drawings, FIGS. 1 to 5 show a first embodiment. A cover device 1 comprises two similar but (in this embodiment) not identical bodies 2 and 3. Each of the bodies is an elongate strip which is preferably of length (in direction A) of approximately the height of a door to which it is to be affixed. Alternatively, it may be of reduced height. The bodies will be placed in a position on the door and frame where a child's (or adult's) fingers are likely to be impinged upon if the child uses their fingers between door and frame. The strips are formed of plastic material such as polypropylene, PVC or other material and includes two different types of plastic, one of which is more rigid than the other. They may be co-extruded to form single articles comprising two materials. The rigid parts comprise generally flat panel portions whilst the less rigid parts, which may be flat or curved, form hinge parts (living hinges) in the finished strip. The parts are identical apart from their innermost edge.

Body one will now be described in detail.

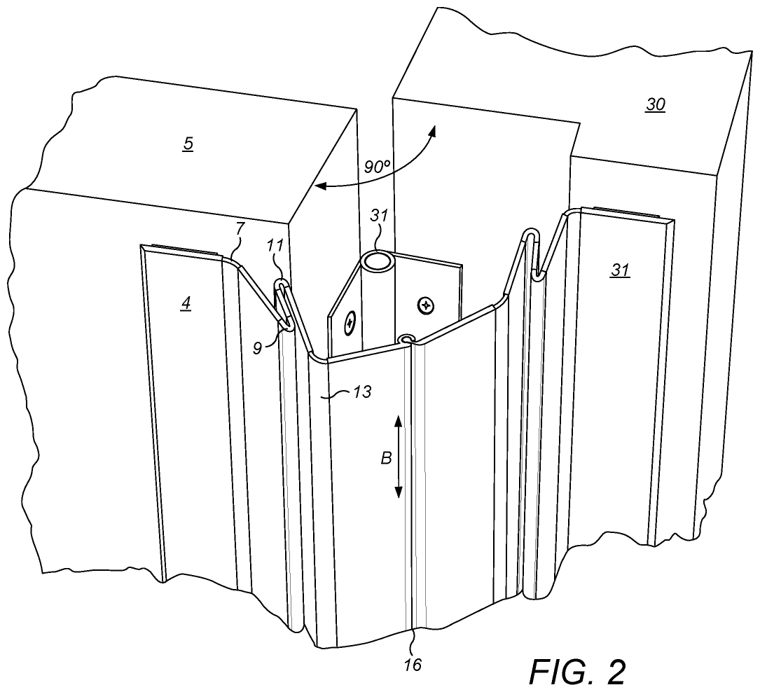

This comprises a first outer panel 4 adapted to be fixed to a face of door 5 (FIG. 2). A layer of double-sided tape 6 is fixed to one face of panel 4 affixing this to the door 5. However, other methods of attaching the panel to the door may be used, such as screws, brackets and so on.

Adjacent to panel 4 is a strip of more flexible plastic 7 and this may, as shown, be of reduced depth compared to the depth of panel 4. This can therefore act as a hinge.

The next panel is another rigid panel 8. Note that in general the rigid panels are of greater width (the dimension of the panel in a direction perpendicular to the hinge lines) than the less rigid ones, but this is not necessarily so in all embodiments.

The next part is a hinge portion 9 which is preferably, together with the other hinge portions, formed of a less rigid, flexible, plastic material (although it may all be formed of the same plastic material in some embodiments with flexibility being obtained by reduced depth portions or otherwise).

The next portion 10 is another rigid planar portion and the other end of this connects to a further hinge 11. A further rigid planar panel 12 extends from hinge 11, followed by a hinge 13.

FIG. 1 shows how the strips may be manufactured (typically by extrusion) such that hinge parts 9 and 11 are already bent (i.e. pre-formed in their bent disposition) to subtend an angle of between their ends of less than 90° (the angle Figure of 1). Thus, the strip is formed with a “memory profile” of these angles, but the hinges can open out to “extend” the strip, or closed to “shorten” the strip, and will then return to the initial “memory” position. The hinges can allow movement between substantially 180° (ie where the adjacent rigid panel such as panels 8 and 9 are in line with each other) to substantially 60°. Where the panels 8, 10 and 12 lie substantially flat upon each other such a panel 10 lies flat upon panel 8 (or closed to shorten the strip).

By “extend” or “shorten” is meant to increase or decrease the distance in space between the ends (i.e. straighten out or increase the bends in the body), so that when in situ a door can be opened to increase the distance between a part of it and the frame, or closed to reduce the distance.

Hinge 13 is a hinge similar to that of hinge 7. A further planar panel 14 leads to the distal (free) end 15 which is formed to include (at least part of its length) a channel 16. This is achieved by part 15 having a part cylindrical or at least concavely arcuate form, forming a channel within having an opening 17. The opening preferably faces in a direction generally away from panel 4 (when the article is manufactured) but may otherwise disposed, and in the embodiment shown is at an angle.

Part 3 is similar to part 1 apart from the distal edge 18. Instead of having a channel formed in it, this forms a bulbous protrusion 19 intended to locate within channel 16. As shown, this may be of width (at its widest point) greater than the width of at least part of the rigid section 20 which is adjacent to it, and the opening 17 of the channel is less than the width of the protrusion 19 such that when the protrusion is in place it cannot simply be pulled out easily.

The protrusion can be otherwise shaped. Preferably it has a part-circular cylindrical cross-section and the channel has a corresponding cylindrical internal cross-section so that the two can relatively rotate.

The remainder of body strip 3 is identical to that of body strip 2.

The two parts may therefore be joined by sliding one part into the other from the top or bottom, such that the protrusion 19 locates within channel 16.

Alternatively, by arranging for channel 16 and its opening 17 to have some flexibility such that it can be resiliently deformed to enlarge opening 17, the protrusion can be pushed in by a snap fit. Once, the enlarged protrusion is located the opening will resiliency close, requiring considerable force to pull protrusion 19 out.

When assembled together the two parts may therefore hinge relative to each other about the joint formed between protrusion 19 and channel 16, and also a degree of longitudinal movement is enabled (typically up or down in a vertical direction when the bodies are mounted between the door and frame). The joint between the bodies therefore acts as hinge between panels 14 and 20 (the panel adjacent to protrusion 19) but also enables for relative longitudinal movement. It is this relatively longitudinal movement that can enable one of the strips to move longitudinally relative to the other to accommodate a rising butt hinge on a door for example.

FIG. 2 shows the strips mounted between a door 5 and frame 30. The door is opened around 90° relative to the frame and this is typically the position at which the door is opened in order for the bodies to be mounted on the respective door and frame by virtue of panels 4 and 31, each being affixed to the respective door and frame by double-sided tape, screws or otherwise.

FIG. 2 shows a rising butt hinge 31 and illustrates by arrow B the direction which relative movement can be achieved.

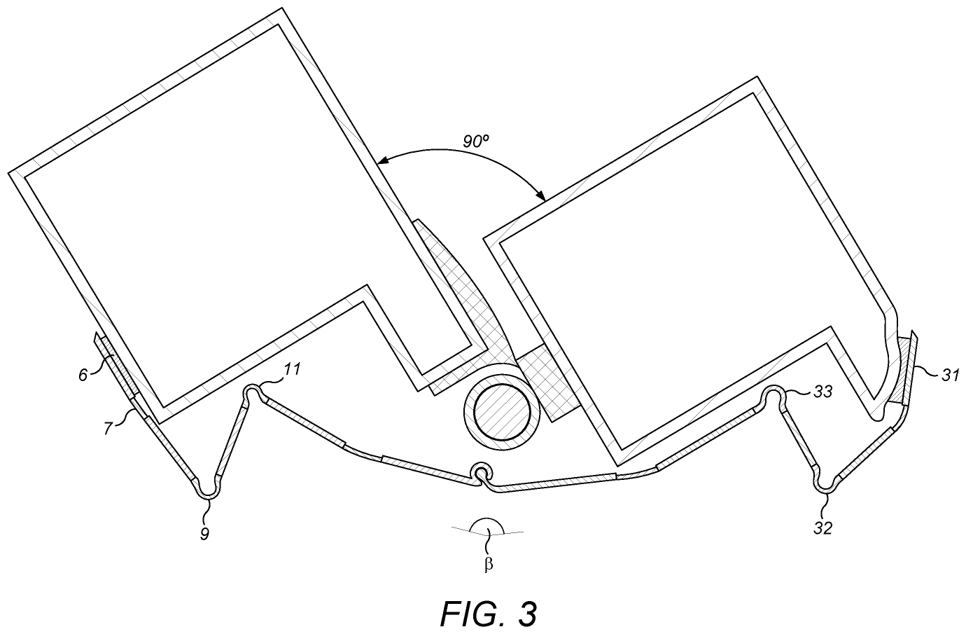

FIG. 3 is a top view and shows how as the door is opened further the two bodies 2 and 3 can open about hinges 9 and 11 of the one part, and 32 and 33 on the other part. The embodiment shown has the protrusion part 19 of body 3 extends at an angle β, to rigid part 20, of less than 180° (typically but not necessarily greater than 90°). The channel is arranged with its opening angle similarly.

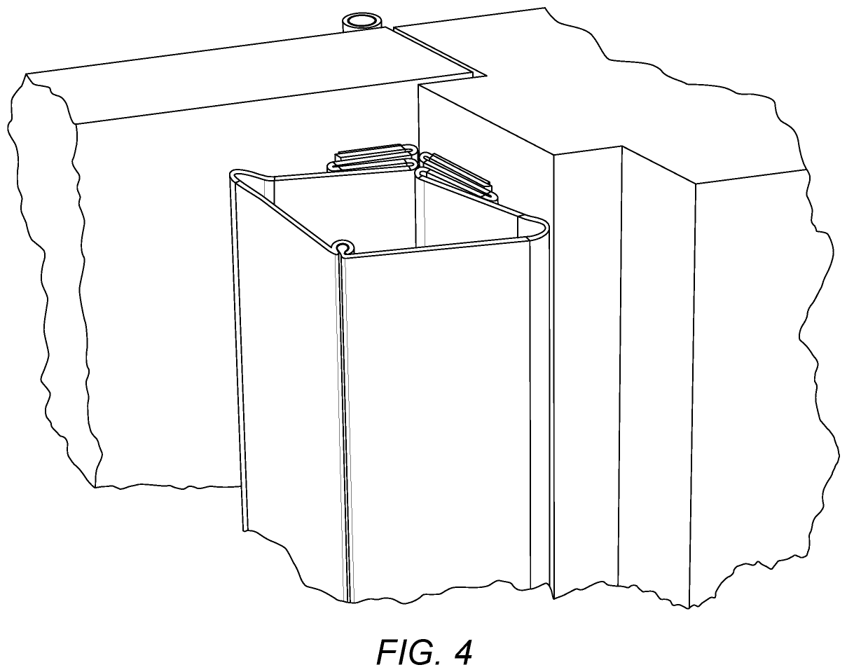

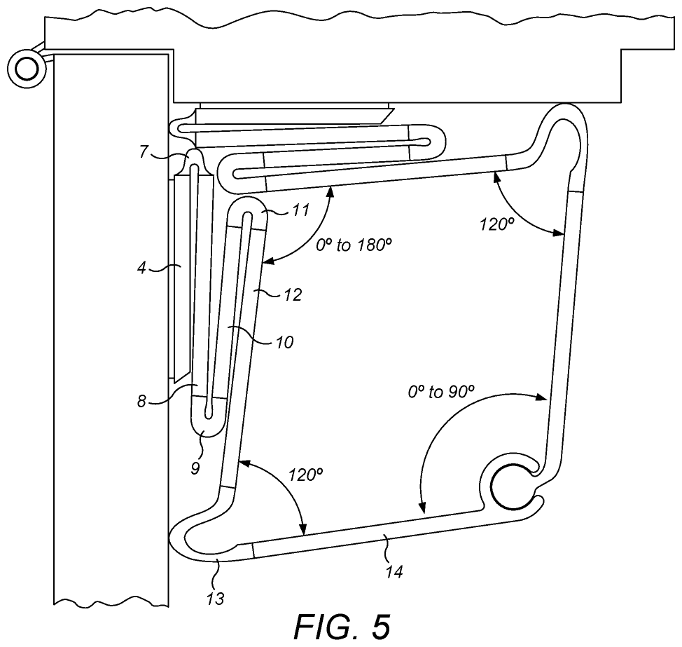

FIGS. 4 and 5 show the situation when the door is fully closed. For each body the parts are folded in the same way. Referring to body 2, the parts are folded upon each other such that, by virtue of hinges 7, 9 and 11, panels 4, 8, 10 and 12 lie substantially against each other flexed together by the hinges.

The zone defined by flexible panel 13 (see FIG. 1) and the body is therefore hinged by around 90° (i.e. a 120° angle around hinge formed by zone at this point.

As is shown in the Figures, at all dispositions, a child's fingers are prevented from entering the space between a door and frame and being possibly trapped.

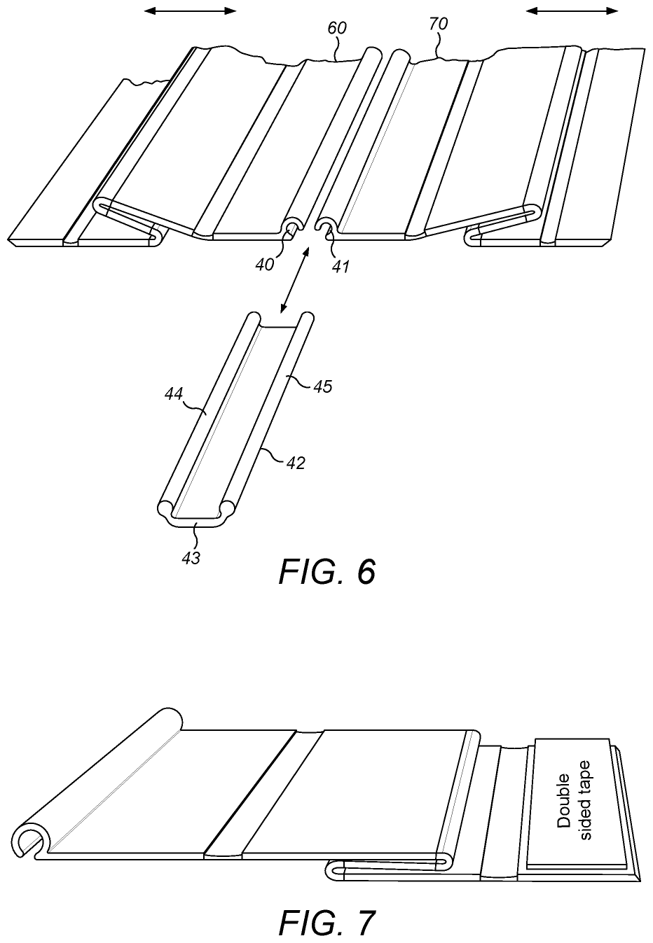

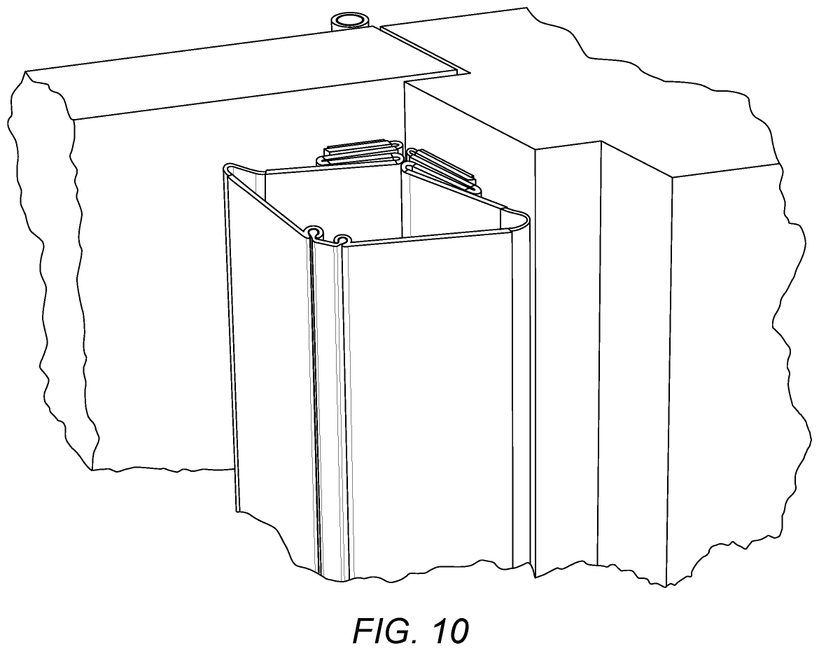

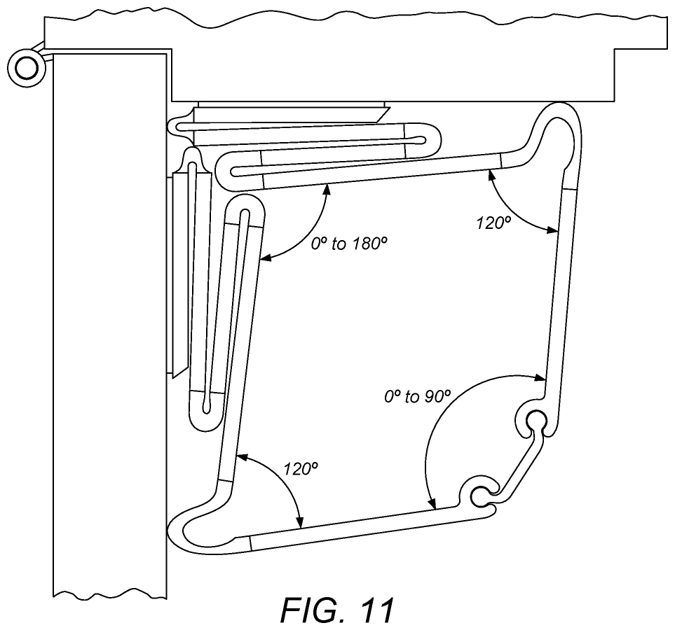

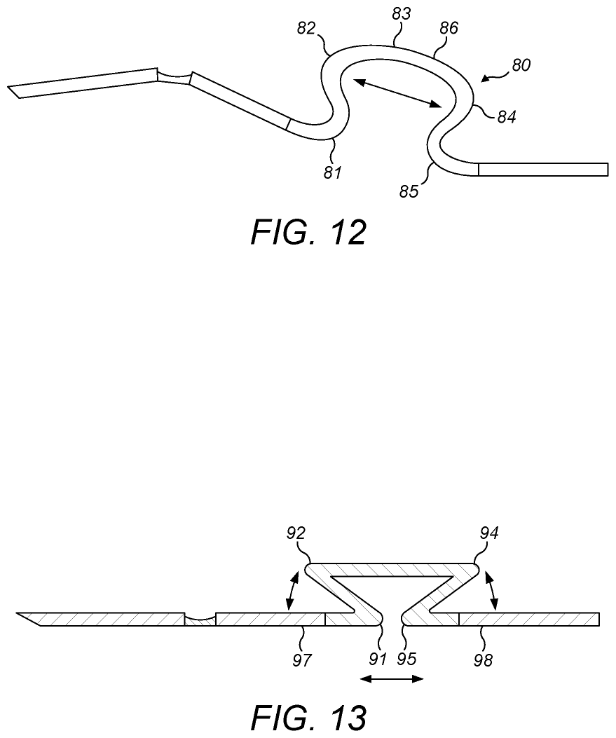

FIGS. 6 to 11 show a further embodiment in which, instead of one of the bodies having a female connector (channel) and the other having a male connector (protrusion), both bodies 60, 70 have a female connector in the form of a channel 40, 41. Thus, both bodies are exactly the same in this embodiment which therefore has the advantage that both bodies are the same and therefore can be made from the same extrusion, cut into sections, for example.

In this embodiment, a separate connecting member 42 is provided. This might of a more flexible plastic than the plastic used for the rigid panels, such as panel 12, or an equally rigid plastic and this includes a flat central elongate panel 43 and two lateral protrusions 44, 45. Each of these extend at an angle of 180° to the angle of the planar part and include a protrusion in the form of a bulbous cross-section part 46, 47 of greater width than at least the part of the flat panel 43 adjacent to them and which is adapted to locate within a corresponding one of channels 40 and 41.

In use, the joining part 42 can be inserted between bodies 2 and 3 either from the top or bottom when located within the slots, or by a push snap-fit (where the openings are flexible and formable) as desired. This therefore provides for the relative movement both rotationally and an elongate movement between the two bodies similar to that of the embodiment of FIGS. 1 to 5.

Alternatively both bodies may have a male connector (protrusion) and the joining member has two female connectors, or the joining member may have one male and one female edge and the bodies be the same bodes 2 and 3 for example.

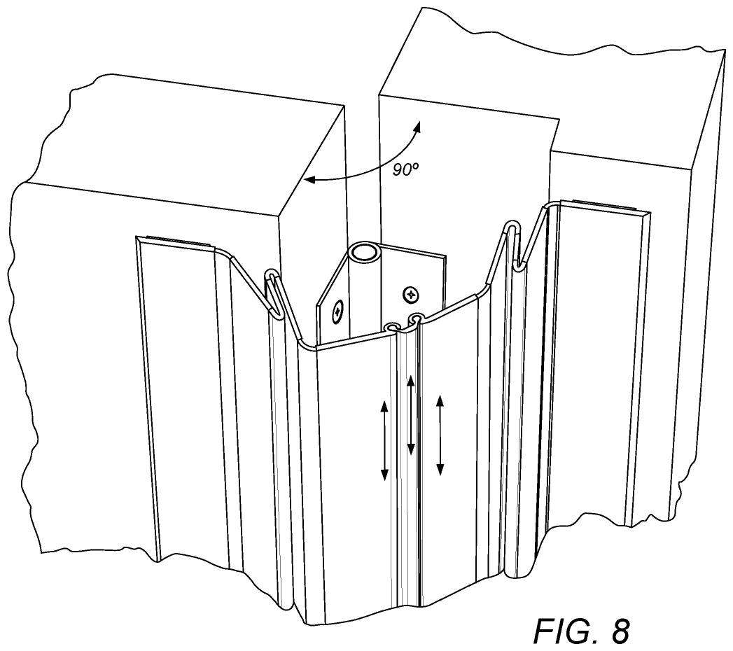

FIG. 7 shows one of the bodies with some of the parts flattened against others.

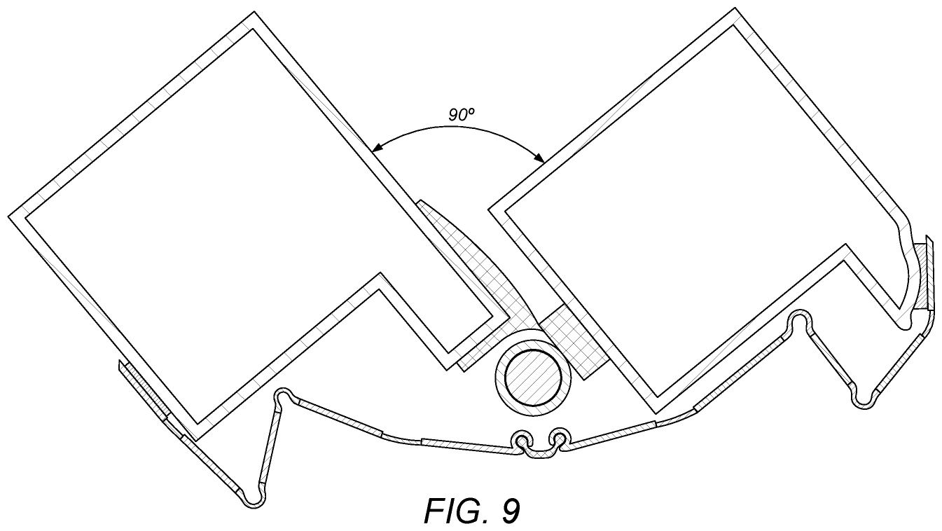

FIGS. 8 to 11 are equivalent to FIGS. 2 to 5 showing the embodiment of FIG. 6 in use. As shown, the two parts may move relative to each other in an elongate (vertical) direction to allow for rising butt hinges or other circumstances.

The combination of panels and hinges 4 to 14 of each body enables the effective length of each body to vary to increase as the door is opened and decrease as the door is closed to therefore enable a wide variety of door openings and sizes to be accommodated.

Other configurations which use two bodies hingably joined may be envisaged within the scope of the invention.

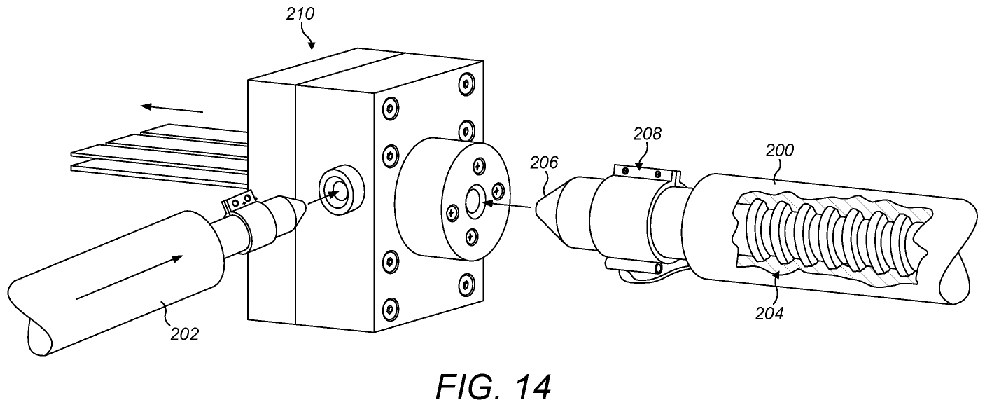

FIG. 12 is an alternative embodiment in which in at least one of the bodies, instead of separate hinges 9, 11 and 13 and panels 8 to 10 and 12, there is provided a single flexible panel 18 which is formed in a generally U shape as shown. This includes a first hinged section 80 which subtends an angle of greater than 270°, a second section 82 with an external angle of more than 90°, a curved rear face 83 and some hinge parts 84, 85 to 81 and 82 respectively. Thus, this in effect forms a U shape having a bulge at it closed end and a narrower waist part 87, shown by dashed lines.

This part can therefore expand as a door is opened or can compress upon itself with hinges 81 and 82 towards each other. As the door is closed it can also fold upon each other upon itself.

FIG. 13 shows another embodiment, similar to that of FIG. 12, in which instead a curved hinge part the hinges are formed by planar and angled hinges parts having a defined “memory” angle 91, 92, 95, 94. Clearly this will work in the same manner as the embodiment of FIG. 12 and many other embodiments, including ones which are generally very triangular cross-section for the flexible part highlighted in FIGS. 12 and 13 (i.e. parts 81 to 86) or other configurations. The parts may hinge towards or away from each other.

The hinge part shown may change shape in order for the guard to reach the closing frame for different types of door. The hinge parts will essentially move in the direction of the arrow, i.e. closing parts 91 and 95 towards each other and causing hinges 92 and 94 to move “downwardly” to close parts 97 and 98.

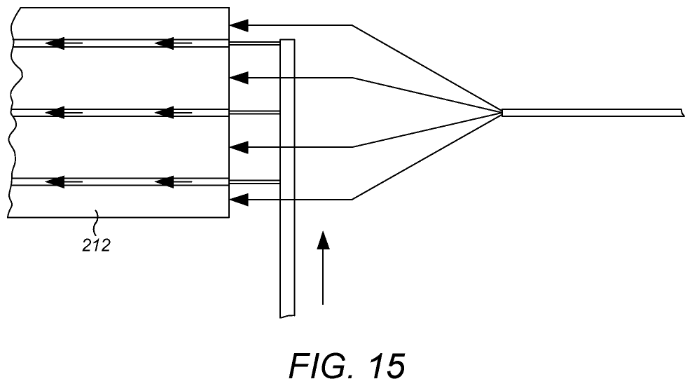

FIGS. 14 and 15 show, very schematically, a co-extrusion technique. Co-extrusion techniques are well known in themselves. Any convenient method may be used. The more rigid plastic material (e.g. UPVC) is applied to a first nozzle 200 and the second plastic material (also UPVC for example) is applied to a second nozzle 202. Each nozzle includes a screw 204 (not shown in nozzle 202) which drives the plastic to the outlet 206. The plastic is heated to a molten state by heaters 208 at each nozzle.

The outputs are applied to an extrusion die 210. In the embodiments shown the outputs are applied at 90° to each other. As shown in FIG. 15 the die is shaped to extrude (‘co-extrude’) both plastic materials simultaneously to obtain the profile (shown schematically only) 212.

1. A cover device for covering the angle formed between the edge of a hinged door and a doorframe, comprising:
first and second elongate bodies, each body having substantially parallel sides and divided by hinge lines parallel to the sides into a plurality of elongate panels,
wherein at least some of the panels are hingable relative to an adjacent panel in order to enable at least some of the panels to concertina relative to each other, the first body being mountable at one end to the door and the second body being mountable at one end to a frame relative to which the door hinges, and the respective free ends of the first and second bodies being removeably hingably connected together and which enables a degree of relative movement of one body, in a longitudinal direction parallel to the hinge lines, relative to the other body,
wherein the hingeable connection between the bodies is by means of features comprising at least one longitudinal channel and at least one longitudinal protrusion which locates within the channel to be removeably held within it but able to move longitudinally with respect to it, and thereby to act as a hinge whilst enabling the relative longitudinal movement between the elongate bodies.

2. The cover device as claimed in claim 1, wherein one body comprises a channel at its free edge, and
wherein the other body comprises a protrusion, the protrusion locating within the channel and being removeably held therein by virtue of the protrusion being of greater width than the opening of the channel.

3. The cover device as claimed in claim 2, wherein there is a waist, narrower than the nearest part of the protrusion between the protrusion and the adjacent part of the body bearing the protrusion.

4. The cover device as claimed in claim 1, wherein the hingeable connection between the first and second bodes comprises a connection member adapted to connect the free ends of the first and second bodies for providing hinged elongate channel and protrusion connections therewith.

5. The cover device as claimed in claim 4, wherein the connection member device has two edges and connects to the first and second bodies by cooperating protrusions and channels, provided on the edges of the further connection member and the free ends of the bodies.

6. The cover device as claimed in claim 1, wherein at least one of the bodies is formed of two different plastics having different rigidities.

7. The cover device as claimed in claim 1, wherein at least one of the bodies includes comprises a collapsible zone having at least two hinges such that part of the body can collapse to concertina generally flat against each other.

8. The cover device as claimed in claim 7, wherein
an accurate part is formed between said two hinges.

9. The cover device as claimed in claim 7, further comprising: at least one planar portion and at least one further hinge between said two hinges.

10. A method of forming a cover device as claimed in claim 6, comprising the step of forming the at least one body by co-extrusion of at least two plastic materials.

11. A door and frame protected by a cover device as claimed in claim 1, mounted between the door and frame.
